(19) United States
(12) Patent Application Publication
(10) Pub. No.: US 2020/0298253 A1
(43) Pub. Date: Sep. 24, 2020

(54) PRESSURE SPRAYER NOZZLES

(71) Applicant: EXEL Industries, Paris (FR)

(72) Inventors: George Leigh WALTERS, West Midlands (GB); Nicolino IACIOFANO, West Midlands (GB)

(73) Assignee: EXEL Industries, Paris (FR)

(21) Appl. No.: 16/826,964

(22) Filed: Mar. 23, 2020

(30) Foreign Application Priority Data
Mar. 21, 2019 (GB) 1903905.6

(51) Int. Cl. B05B 1/12; B05B 9/01

(52) U.S. Cl. CPC B05B 1/12; B05B 9/0413; B05B 9/01

(57) ABSTRACT

A pressure sprayer nozzle includes an inlet channel for accepting liquid from a pressure sprayer, an outlet head and a plurality of liquid outlet portions. The outlet head is rotatable between: a first position in which a first of the outlet portions is in fluid communication with the inlet channel so that liquid can flow from the inlet channel to, and out of, the first of the outlet portions; and a second position in which a second of the outlet portions is in fluid communication with the inlet channel so that liquid can flow from the inlet channel to, and out of, the second of the liquid outlet portions. The first of the liquid outlet portions differs from the second of the liquid outlet portions to allow the selection of a first outlet spray type by rotating the outlet head.

This invention relates to pressure sprayer nozzles and pressure sprayers including such nozzles.

Of particular interest are garden pressure sprayers which are used as a quick and efficient way to deliver, for example, water, plant feed, pesticides, herbicides and fungicides in the garden. Pressure sprayers typically comprise a vessel for holding liquid to be sprayed, a pressurizing mechanism for pressurizing the vessel and a liquid outlet arrangement for allowing the liquid to be sprayed. Such pressure sprayers are typically supplied with a single variable outlet nozzle which can be adjusted by a screwing action to give an outlet varying between a fine jet pattern and a misting pattern. Often these nozzles can be replaced by nozzles which have different distribution patterns such as flat fan spray nozzles (of varying angles) or conical distribution nozzles. These different nozzles are used for different applications and different coverage areas by a user.

However, it is inconvenient for a user to have to replace nozzles i.e. to change between different types of nozzles and this can be a fiddly job and carries with it a risk of nozzles being lost.

Thus, it would be desirable to provide an alternative. In doing this it needs to be noted that typically pressure spraying nozzles need to be relatively lightweight and of simple construction to meet user expectations in terms of usability and cost.

According to one aspect of the present invention there is provided a pressure sprayer nozzle comprising a main body portion having an inlet channel for accepting liquid from a pressure sprayer, an outlet head which is rotatably mounted on the main body portion and comprises a plurality of liquid outlet portions, and a seal provided between the main body portion and the outlet head for sealing between an outlet of the inlet channel and a respective inlet of at least one of the liquid outlet portions,

the outlet head being rotatable between:
a first position in which a first of the plurality of outlet portions is in fluid communication with the inlet channel so that in use liquid can flow from the inlet channel to, and out of, the first of the plurality of outlet portions; and a second position in which a second of the plurality of outlet portions is in fluid communication with the inlet channel so that in use liquid can flow from the inlet channel to, and out of, the second of the plurality of liquid outlet portions, wherein the first of the plurality of liquid outlet portions differs from the second of the plurality of liquid outlet portions such as to allow the selection of a first outlet spray type by rotating the outlet head to the first position and the selection of a second outlet spray type by rotating the outlet head to the second position.

This can avoid a user having to go to the lengths of manually changing an outlet component on a nozzle (or the whole nozzle) every time a different outlet spray type is desired from a pressure sprayer.

A first of the liquid outlet portions may comprise a mounting portion to which an outlet component is mountable.

This can allow the provision greater flexibility by allowing the use of different outlet components with the nozzle. Thus, in such a case not only can the nozzle allow the selection between at least two different types of outlet by virtue of rotation of the outlet head, the nature of at least one of those two outlets may be further selected by the fitting of particular outlet component. This gives the convenience of the availability of different outlet types without needing to mount these separately due to the multiple outlets provided on the outlet head whilst retaining flexibility for the user.

The nozzle may be supplied with or without an outlet component mounted, or for mounting on the mounting portion.

The mounting portion may comprise a turret portion onto which a selected outlet component is mountable.

The mounting portion may comprise a thread onto which a selected outlet component with a complementary thread can be mounted.

The mounting portion may comprise one half of a bayonet fitting arrangement onto which a selected outlet component with a complementary other half of a bayonet fitting arrangement can be mounted.

The first of the liquid outlet portions may comprise a mister outlet, which may comprise the mounting portion and a mister nut, with a mister orifice, mounted on the mounting portion. Here the mister nut is an outlet component.

The first of the liquid outlet portions may comprise an anvil outlet, which may comprise the mounting portion and an anvil nut, with an anvil portion, mounted on the mounting portion. Here the anvil nut is an outlet component.

A second of the liquid outlet portions may comprise an integral outlet component. This avoids the user needing to separately mount an outlet component to the outlet portion.

A second of the liquid outlet portions may comprise a fan outlet for producing a fan spray pattern.

Preferably the outlet head comprises at least three liquid outlet portions. In such a case one of the liquid outlet portions may comprise a mounting portion to which an outlet component may be mounted and two of the liquid outlet portions may each comprise a respective integral outlet component. Typically, each respective integral outlet component will be arranged for producing a respective type of outlet pattern—say one or more of: a flat fan spray output with a first angular coverage, a flat fan spray output with a second angular coverage, a conical distribution spray output, and so on.

The nozzle may comprise a retaining clip for releasably securing the outlet head on the main body portion.

This provides a particularly simple and effective mechanism for constructing the nozzle so as to resist unintentional opening during rotation of the outlet head, whilst allowing for disassembly for cleaning.

The retaining clip may comprise at least one engagement portion for releasable engagement with a complementary engagement portion on the outlet head.

The retaining clip may comprise a clip body portion for bearing on a surface of the main body to hold the outlet head on the main body portion during relative rotation between the outlet head and the main body.

The retaining clip may be horseshoe shaped. This can facilitate mounting and removal of the clip whilst allowing it to perform its retaining function.

The at least one engagement portion may comprise a projection on the clip body portion. The complementary engagement portion on the outlet head may comprise a recess or cut-out.

The retaining clip may comprise three engagement portions. A first of the engagement portions may be provided towards a midpoint of the clip, a second provided towards a first end of the clip and a third towards a second end of the clip.

The outlet head may be cup shaped comprising a base portion and a sidewall portion defining an interior of the cup which is arranged to receive the main body portion. The liquid outlet portions may be provided on the base portion. The sidewall may extend from the base towards the rear of the main body. The retaining clip may be engaged with the sidewall when the outlet head is on the main body and the retaining clip is in place. The clip body portion may bear on a surface of the main body which faces away from the base of the cup when the outlet head is on the main body and the retaining clip is in place. The clip body portion may bear on a rear surface of the main body when the outlet head is on the main body and the retaining clip is in place.

The retaining clip may be resilient and elastically deformable away from a first engaged position in which the at least one engagement portion is engaged with the complementary engagement portion on the outlet head to a second position in which the at least one engagement portion is not engaged with the complementary engagement portion on the outlet head and the retaining clip is disengagable from the outlet head so allowing removal of the outlet head from the main body.

The seal may comprise a first O-ring mounted on the main body portion so as to surround the outlet of the inlet channel and face a surface of the outlet head.

The main body portion and the outlet head may be arranged so that in the first position a first of the plurality of liquid outlet portions is rotationally aligned with the inlet channel and the first O-ring seals around the inlet of the first liquid outlet portion and in the second position a second of the plurality of liquid outlet portions is rotationally aligned with the inlet channel and the first O-ring seals around the inlet of the second liquid outlet portion.

A plurality of O-rings may be mounted on the main body portion so as to face the surface of the outlet head, said plurality comprising the first O-ring which surrounds the outlet of the inlet channel and at least one further O-ring.

The or each O-ring may be housed in a respective recess provided in the main body portion.

Preferably the number of O-rings in the plurality of O-rings matches the number of liquid outlet portions in the plurality of liquid outlet portions. Preferably an angular spacing between the O-rings matches an angular spacing between the inlets of the liquid outlets. Preferably the radial location of the O-rings matches with the radial location of the inlets of the liquid outlets. More generally put preferably the location and dimensions of the O-rings register with those of the inlets of the liquid outlets.

The O-rings may be positioned and dimensioned so that when the outlet head is in the first position with the first O-ring sealing around the inlet of the first liquid outlet portion, each of the further O-rings seals around the inlet of a respective other one of the liquid outlet portions.

Preferably there are at least three O-rings. Preferably there are at least three O-rings and at least three liquid outlet portions.

The provision of a plurality of O-rings between the main body and the outlet head can help to provide stability between the main body and the outlet head and ensure that these parts remain square to one another. This in turn can help ensure that there is a good seal between the first O-ring and the inlet of the respective liquid outlet portion. If only the first O-ring is provided it has been found that an inferior seal results. The O-rings provide a resilient and sealing mounting between the main body and the outlet head.

Further the provision of the further O-rings such that they are aligned with the inlets of the liquid outlets that are not currently selected for use, and hence not aligned with the liquid inlet in the main body, helps to seal the liquid outlets which are not currently in use against leakage.

According to another aspect of the present invention there is provided a pressure sprayer comprising a vessel for holding liquid to be sprayed, a pressurising mechanism for pressurising the vessel to yield a pressure in the vessel for driving liquid out of the vessel during spraying and a liquid outlet arrangement for allowing liquid to exit the vessel and leave the sprayer during spraying, wherein the liquid outlet arrangement comprises a pressure sprayer nozzle as defined above and a vessel outlet portion which leads towards the pressure sprayer nozzle.

The liquid outlet arrangement may comprise a tube leading from the vessel to the nozzle. The liquid outlet arrangement may comprise an outlet portion which is integrally formed with the vessel.

The pressure sprayer may be a garden pressure sprayer. The pressure sprayer may be arranged for delivering one or more of water, plant feed, pesticides, herbicides and fungicides in the garden. The sprayer might be expressed as phytosanitary product delivery pressure sprayer and/or a plant protection product delivery pressure sprayer.

Typically, the pressure sprayer will be manually pressurisable, say by use of a pump action pressurising mechanism.

According to another aspect of the present invention there is provided a spray nozzle comprising a main body portion having an inlet channel for accepting liquid from a source of liquid, an outlet head which is rotatably mounted on the main body portion and comprises a plurality of liquid outlet portions, and a seal provided between the main body portion and the outlet head for sealing between an outlet of the inlet channel and a respective inlet of at least one of the liquid outlet portions,

the outlet head being rotatable between:
a first position in which a first of the plurality of outlet portions is in fluid communication with the inlet channel so that in use liquid can flow from the inlet channel to, and out of, the first of the plurality of outlet portions; and a second position in which a second of the plurality of outlet portions is in fluid communication with the inlet channel so that in use liquid can flow from the inlet channel to, and out of, the second of the plurality of liquid outlet portions, wherein the first of the plurality of liquid outlet portions differs from the second of the plurality of liquid outlet portions such as to allow the selection of a first outlet spray type by rotating the outlet head to the first position and the selection of a second outlet spray type by rotating the outlet head to the second position.

Note that in general each of the optional features following each of the aspects of the invention above is equally applicable, where context allows, as an optional feature in respect of each of the other aspects of the invention and could be re-written after each aspect with any necessary changes in wording. Not all such optional features are re-written after each aspect merely in the interests of brevity.

The present invention will now be described, by way of example only, with reference to the accompanying drawings in which:

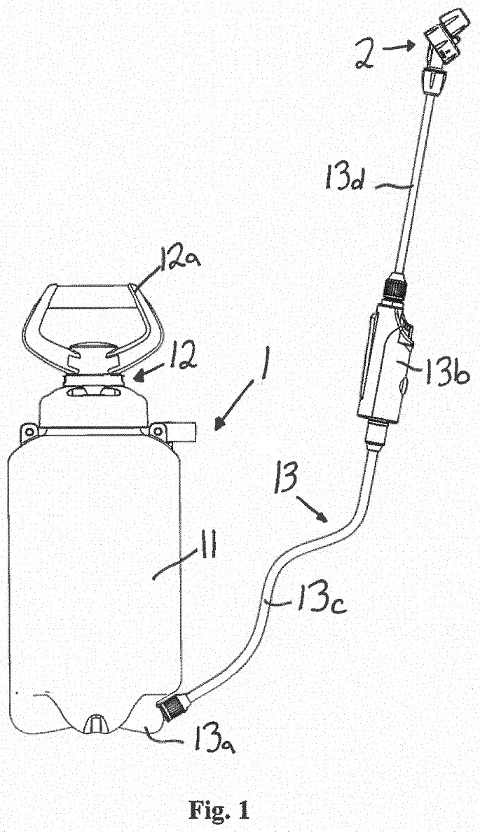

FIG. 1 schematically shows a pressure sprayer;

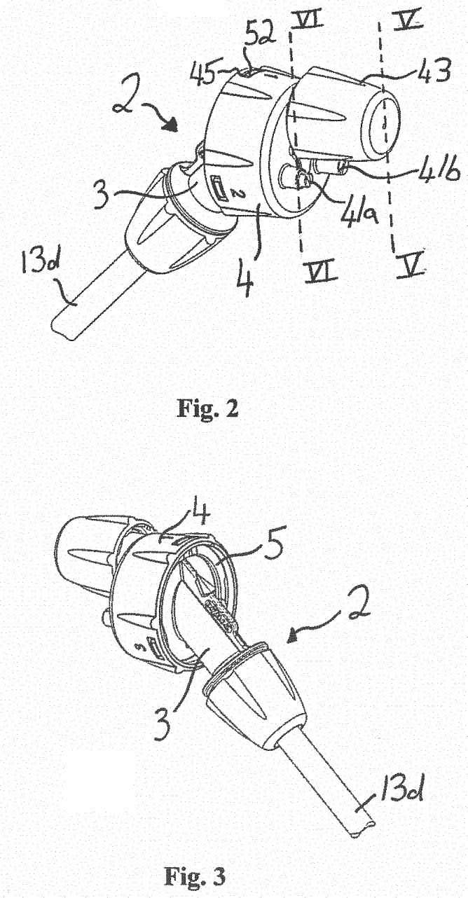

FIG. 2 schematically shows in more detail a nozzle of the pressure sprayer shown in FIG. 1;

FIG. 3 shows the nozzle shown in FIG. 2 but from a reverse angle;

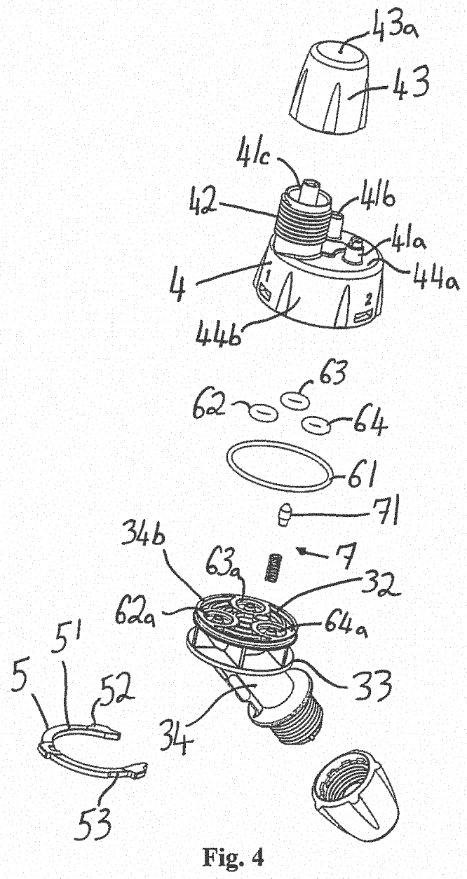

FIG. 4 is an exploded view of the nozzle shown in FIGS. 2 and 3;

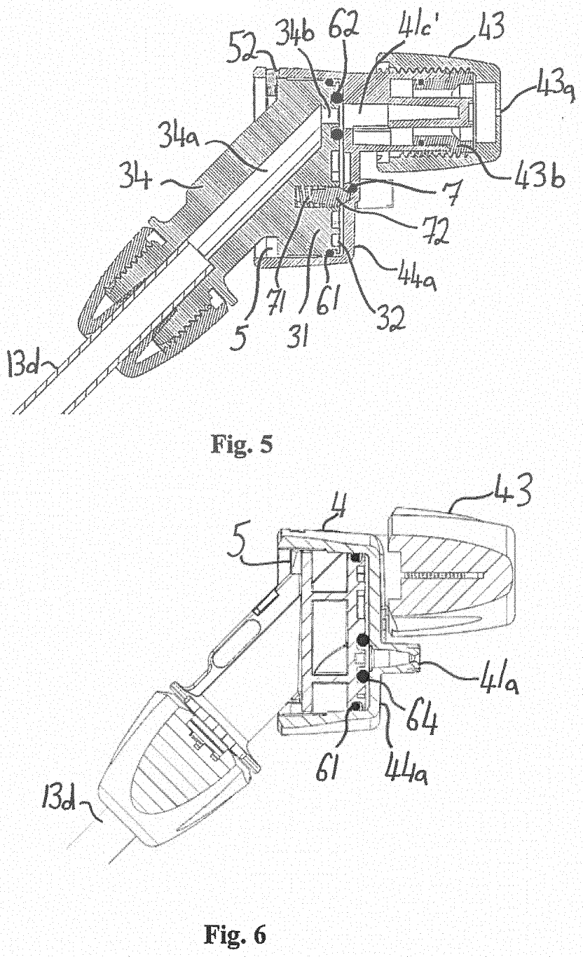

FIG. 5 shows a section on a midline indicated by the dotted line V-V of the nozzle shown in FIG. 2;

FIG. 6 shows a section on a line offset from the midline indicated by dotted line VI-VI of the nozzle shown in FIG. 2; and

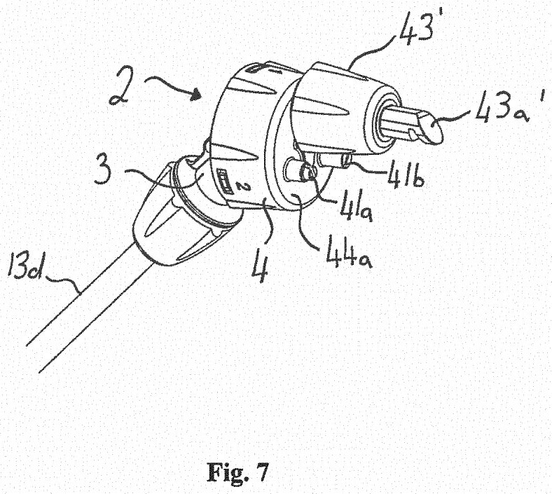

FIG. 7 shows the nozzle of FIGS. 2 to 6 when fitted with an alternative outlet component.

FIG. 1 schematically shows a pressure sprayer which in the present case is a garden pressure sprayer. The pressure sprayer 1 comprises a vessel 11 for carrying a liquid to be sprayed by the pressure sprayer, a pressurizing mechanism 12 for pressurizing the vessel 11 and an outlet arrangement 13. In this embodiment the outlet arrangement 13 comprises a vessel outlet 13a, a user handle and trigger 13b and a nozzle 2. Further, the outlet arrangement 13 includes a flexible tube 13c connecting the vessel outlet 13a to the user handle and trigger 13b and a wand 13d connecting the nozzle 2 to the user handle and trigger 13b.

The structure and functioning of such garden pressure sprayers at the level described above are well known and detailed description of these known components is omitted. What is of particular interest in the present specification is the nozzle 2 and this will be described in more detail further below.

In the present pressure sprayer 1, the pressurizing mechanism 12 is a pump action pressurizing mechanism such that the user may operate a handle 12a of the pump mechanism to pressurize the vessel 11 to make it ready for spraying. The user may then operate the trigger on the user handle and trigger 13b to open a valve (not shown) within the user handle and trigger 13b so as to allow the pressure in the vessel 11 to drive the liquid in the vessel out of the liquid outlet arrangement and in particular out of the nozzle 2. This then allows the user to use the garden pressure sprayer to spray liquid as desired.

Note that other constructions of garden pressure sprayer exist. As an example, there are backpack type sprayers where the vessel is made to be worn on a user's back. Further there are, for example, handheld pressure sprayers where in general the vessel will be smaller and rather than connecting tubes 13c and 13d, a nozzle 2 may be mounted directly on the vessel outlet 13a. In each such case, operation is similar in that a means is provided for pressurizing the vessel and a trigger or some other user operable control is provided for opening a valve to allow liquid to leave the nozzle 2 when it is desired to spray liquid from the vessel.

FIGS. 2 to 7 show the nozzle 2 of the pressure sprayer shown in FIG. 1 in more detail. Referring first to FIGS. 2 to 4, it can be noted that the nozzle 2 comprises a body portion 3, a liquid outlet head 4 and a retaining clip 5. The liquid outlet head 4 is mounted for rotation relative to the body portion 3 and held in place when assembled using the retaining clip 5. These components are shown in an assembled state in FIGS. 2 and 3 and a dissembled state in FIG. 4.

The liquid outlet head 4 comprises a plurality of (in this case 3) liquid outlet portions 41a, 41b and 41c. The outlet head 4 is rotatable between three different operating positions by a user in order to be able to select which of the liquid outlet portions 41a, 41b, 41c is used for delivering liquid 11 from the vessel. In the orientation shown in FIGS. 2, 3 and 4, whichever one of the liquid outlet portions 41a, 41b, 41c is rotated so as to be uppermost is the liquid outlet portion 41a, 41b, 41c which is selected and the outlet from which liquid will be dispensed in use.

It should be noted that each of the liquid outlet portions 41a, 41b, 41c are different from each other. That is to say they are arranged so as to provide a different spraying function for the user when selected. In the present embodiment a first of the liquid outlet portions 41a is arranged to create a fan spray with a first spray angle, a second of the outlet portions 41b is arranged to create a fan spray with a second angle, and a third of the outlet portions 41c is a mister outlet.

The first and second outlet portions 41a, 41b are integral with the outlet head 4. Further their operation in the present embodiment is fixed. That is to say these outlets 41a, 41b are not provided with user adjustable features to allow different output effects. Of course, in some alternatives user adjustability could be incorporated into such outlets.

The third liquid outlet portion 41c is different. This liquid outlet portion 41c comprises a turret shaped mounting portion 42 provided on a main body 44 of the outlet head 4 and a mister nut 43 which is arranged for mounting on the mounting portion 42. As can be seen in FIG. 5, the mister nut 43 includes a mister orifice 43a and a sealing component 43b for sealing against the third liquid outlet portion 41c. In the present embodiment this mounting is achieved by virtue of complimentary threads provided on the mounting portion 42 and the mister nut 43. Further these complimentary threads allow adjustment of the spray pattern deliverable by the third liquid outlet 41c between a fine jet and a misting pattern.

Further it should be noted that different kinds of liquid outlet components to the mister nut 43 may be mounted on the mounting portion 42 if desired by a user. FIG. 7 shows, for example, an anvil outlet nut 43′ with an anvil outlet component 43a′ mounted on the mounting portion 42 in place of the mister nut 43 shown in FIG. 4. As a further alternative a flat fan outlet nut may be mounted on the mounting portion—this may produce a fan having a different angular extent than the fans produced by the first and second liquid outlets 41a, 41b. Of course, other outlet types if available to a user may also be used. This provides the user with the flexibility of mounting different types of outlet to the outlet head 4 if desired. This gives the user the convenience of being able to select different outlets 41a, 41b, 41c merely by rotation of the outlet head 4 combined with the ultimate flexibility of being able to mount different types of outlet component 43, 43′ to the mounting portion 42 if desired.

In this specification the expressions “mister” outlet and “mister” nut are used as is typical in the art of spraying and refer to outlets which are able to produce a spray having a very fine and diffuse pattern of output liquid such that the liquid is dispersed over a volume as it is dispensed rather than being contained in a tight, shaped, stream. A mister outlet often is adjustable between a state giving this type of output pattern on the one hand and a jet on the other hand. Sometimes such an outlet may also be capable of producing a conical distribution pattern between these two extremes. Such outlets are sometimes termed hollow cone outlets or hollow cone nozzles.

In this specification the expressions “anvil” outlet and “anvil” nut are used as is typical in the art of spraying and refer to outlets which produce a fan outlet pattern but with a construction that generally causes the fan to exit the nozzle transversally. These outlets have an anvil like component against which the escaping liquid impacts, helping with dispersion and directing of the liquid being sprayed.

In this specification the expressions “flat fan” outlet and “flat fan” nut are used as is typical in the art of spraying and refer to outlets which produces a distribution pattern in the form of generally two dimension fan with an envelope having a divergence angle determined by the outlet. In such a case the liquid is more contained in a stream that with a mister outlet in misting configuration.

The main body 44 of the outlet head 4 is cup shaped and has a base 44a on which the liquid outlet portions 41a, 41b, 41c are provided and a side wall 44b, which in this embodiment is generally cylindrical. Together the base portion 44a and side wall 44b define an interior which in the assembled state accepts an outlet portion 31 of the main body 3. The outlet portion 31 of the body portion 3 has an outlet face 32 which faces an inner surface of the base 44a of the cup shaped body 44 of the outlet head in the assembled state as shown, for example in FIG. 2. In this assembled state, the side walls 44b of the outlet head 4 extends over the outlet portion 31 of the main body portion 3 and the outlet head 4 is retained in position on the outlet portion 31 of the body portion 3 by the retaining clip 5 which is located behind a rear wall 33 of the outlet portion 31. This can be seen, for example in FIG. 3 and also in the sections shown in FIGS. 5 and 6.

The main body portion 3 further comprises a connector portion 34 which, as shown in for example FIGS. 2 and 3, is arranged to receive the tube 13d from the user handle and trigger 13b. The connector portion 34 comprises a liquid channel 34a which leads to a liquid outlet 34b as shown in FIG. 5. When one of the liquid outlets 41a, 41b, 41c of the outlet head 4 is aligned with the liquid outlet 34b of the main body 3, that outlet 41a, 41b, 41c can be considered as selected for spraying and the outlet 34b of the liquid channel 34a is aligned with an inlet of the respective liquid outlet of the outlet head 4. FIG. 5 shows a situation where the third liquid outlet 41c is in the selected position and thus shows an inlet 41c′ of the third liquid outlet 41c aligned with the liquid outlet 34b of the main body 3. As such there is a fluid communication path through the nozzles such that liquid delivered to the nozzle 2 is allowed out of the selected liquid outlet 41c for spraying.

As will be appreciated, when the outlet head 4 is rotated to a different position for selection of one of the other liquid outlets 41a, 41b then in such a case, a respective inlet of that selected liquid outlet 41a, 41b will be aligned with the liquid outlet 41b of the main body 3.

Seals 61, 62, 63 and 64 are provided between the outlet head 4 and the main body 3. A main seal 61 is provided around a periphery of the outlet portion 31 of the main body 3 for sealing against the inside of the side wall 44b of the outlet head 4. Three O-rings 62, 63 and 64 are provided in respective recesses 62a, 63a and 64a provided in the outlet face 32 of the main body 3. A first of these O-rings 62 is provided around the liquid outlet 34b of the main body and can be termed a primary O-ring 62. In the assembled state as shown in FIG. 5 this primary O-ring 62 serves to provide a seal around the liquid passage through the nozzle 2 and specifically seal between the main body 3 and outlet head 4 around the liquid outlet 34b of the main body 3 and the inlet 41c′ of the selected liquid outlet 41c in the condition shown in FIG. 5. In this condition as shown in FIG. 5, the other two O-rings 63, 64 provide a seal between the main body 3 and the outlet head 4 around the respective inlets into the non-selected liquid outlets 41a, 41b of the feature head. The section shown in FIG. 6 shows the third O-ring 64 sealing around the inlet into the first liquid outlet 41a of the outlet head 4.

Thus, whilst the first O-ring 62 as shown in FIG. 5 performs a primary sealing function for sealing the water flow path through the nozzle 2 to the selected liquid outlet (the third liquid outlet 41c in the orientation shown in FIG. 5). The other O-rings 63 and 64 provide a sealing function around the non-selected outlets at the same time. This helps ensure that leakage out of the non-selected outlets is minimised. That is to say, if liquid leaks passed the primary O-ring 62 (which it has to be expected will occur, at least in some circumstances), leakage of this liquid out of the other non-selected outlets is minimised.

Further it has been found that the provision of the three O-rings 62, 63, 64 in the outlet face 32 serves to improve the seal of the primary O-ring 62 around the main liquid path through the nozzle. This is because the three O-rings 62, 63, 64 act together to provide a resilient sealing mounting between the main body portion 3 and the outlet head 4. This helps to keep the base portion 44a of the outlet head 4 square with the outlet surface 32 of the main body 3 and thus tends to improve the seal provided by the primary O-ring 62.

As can be seen in FIGS. 4 and 5, the nozzle 2 further comprises indexing means 7 for helping a user ensure that the selected liquid outlet is accurately aligned with the liquid outlet 34b of the main body 3. The indexing means 7 in this embodiment comprises a spring loaded pin 71 which locates in a corresponding recess 72 in the outlet head 4 when the outlet head 4 is in one of the three desired rotational orientations for selection of the respective one of the liquid outlets 41a, 41b, 41c.

Thus, it will be noted that the three O-rings 62, 63, 64 are dimensioned and arranged so as to register with the inlets of the three liquid outlets 41a, 41b, 41c such that whenever one of the outlets 41a, 41b, 41c is selected and so its inlet is sealed by the primary O-ring 62, the inlets into the other outlets are sealed by the other O-rings 63 and 64.

As mentioned above, in the present embodiment the retaining clip 5 serves to retain the outlet head 4 on the main body 3 in the assembled state. In the present embodiment, the retaining clip 5 is horse shoe shaped and has a main body portion 51 from which project a plurality (in this case three) engaging portions 52. As can be seen, for example in FIGS. 2 and 5, these engaging portions 52 are arranged to be received in corresponding engagement portions 45 in the outlet head 4. In the present embodiment these complimentary engaging portions 45 are in the form of cut-outs 45 provided in the side wall 44b of the outlet head 4.

The retaining clip 5 is resilient and deformable between the engaged position shown in for example FIGS. 2 and 5 with the engaging portions 52 of the clip 5 engaged in the complimentary engagement portions 45 of the outlet head 4 and a deformed position in which at least one of the engagement portions 52 of the clip 5 is removed from its corresponding engagement portion 45 in the outlet head 4. This facilitates the removal of the clip 5 and hence the removal of the outlet head 4 from the main body 3. This can facilitate the user removing the clip 5 and hence outlet head 4 so as to dissemble the unit for cleaning. In the present embodiment, recesses 53 are provided in the main body portion 51 of the clip 5. This can allow a user to insert a tool into one of the recesses 53 for deforming the clip 5 out of engagement with the outlet head 4. In alternatives a different construction of retaining clip could be used, or a different arrangement altogether for mounting the outlet head on the main body which did not make use of such a clip.

In the present embodiment the primary parts of the nozzle 2 are of injection moulded plastic, say of ABS and/or POM (also known as Acetal) plastics material. The retaining clip 5 may be of POM and the other main parts of ABS say. The main body 3 may be moulded in a single piece. The body 44 of the outlet head may be moulded in a single piece. The retaining clip 5 may be moulded in a single piece. The mister/anvil nut 43, 43′ and a nut for mounting the tube 13d to the main body 3 again can be injection moulded. The main seal 61 and O-rings 62-64 may be of elastomer. The indexing pin 71 may, say, be of plastics material or of metallic material. The spring will typically be of metallic material. The use of single piece components further simplifies manufacture and assembly. Overall it will be seen that the nozzle has a simple construction with a minimum of individual components but still allows disassembly for cleaning. This can provide usability, reliability and light weight whilst containing costs.

Whilst the present nozzle is particularly suitable for use as a pressure sprayer nozzle, a spray nozzle with some or all of the above described features might be provided for different purposes. Such a spray nozzle might for example be used on a garden hose as part of a hose gun, a watering lance or so on. Alternatively, a pressure sprayer of the above type may be arranged for connection to a garden hose for the delivery of water to the sprayer and/or for assisting in pressurisation.

As mentioned above, garden pressure sprayers are of particular interest and it should be noted that such pressure sprayers can have other uses—say a garden pressure sprayer may be used for cleaning—say of vehicles and/or furniture—as well as the watering or treating of plants. Further similar pressure sprayers to that shown in the drawings may be provided for professional purposes such as spraying chemicals in an agricultural or other context. Such devices are still considered as pressure sprayers in this specification and the present nozzles may be used with such pressure sprayers. Further such devices may have a similar overall construction to the garden pressure sprayers described above.

In general terms the present type of nozzles and/or pressure sprayers can used in a variety of sectors/end applications including:
Gardening—for the application of say water, proprietary fertilizers (and food, plant stimulants), herbicides, pesticides and fungicides as well as homemade remedies (eg: vinegar, liquid manure, bicarbonate of soda salt based remedies). In at least some cases also similarly in agriculture as well as in home gardening.
Hygiene—for the application of say detergents, disinfectants.
DIY—for the application of say paint, preservatives, washing solutions.
Automotive/Industrial—for the application of say oils, paints, degreasing chemicals.

They can also be used with differing classes of liquids including:
Acidic products—Say oils and petroleum derivatives, dilute acids, detergents, aliphatic solvents, aromatic or chlorinated solvents, strong but non-oxidising acids.
Neutral products—Say water, herbicides, insecticides, fungicides.
Alkaline products—Say bleach, disinfectants, strippers, caustic soda, concentrated alkaline products, vehicle cleaners.

1. A pressure sprayer nozzle comprising:
a main body portion having an inlet channel for accepting liquid from a pressure sprayer, an outlet head which is rotatably mounted on the main body portion and comprises a plurality of liquid outlet portions, and a seal provided between the main body portion and the outlet head for sealing between an outlet of the inlet channel and a respective inlet of at least one of the liquid outlet portions,
the outlet head being rotatable between:
a first position in which a first outlet portion of the plurality of outlet portions is in fluid communication with the inlet channel so that in use liquid can flow from the inlet channel to, and out of, the first outlet portion of the plurality of outlet portions; and
a second position in which a second outlet portion of the plurality of outlet portions is in fluid communication with the inlet channel so that in use liquid can flow from the inlet channel to, and out of, the second outlet portion of the plurality of liquid outlet portions,
wherein the first outlet portion of the plurality of liquid outlet portions differs from the second outlet portion of the plurality of liquid outlet portions such as to allow the selection of a first outlet spray type by rotating the outlet head to the first position and the selection of a second outlet spray type by rotating the outlet head to the second position.

2. A pressure sprayer nozzle according to claim 1 in which the first outlet portion of the liquid outlet portions comprises a mounting portion to which an outlet component is mountable.

3. A pressure sprayer nozzle according to claim 2, in which the mounting portion comprises a turret portion onto which the outlet component is mountable.

4. A pressure sprayer nozzle according to claim 3, in which the outlet component is selectable among a plurality of outlet components that are each of a different type relative to each other.

5. A pressure sprayer nozzle according to claim 2 in which the first outlet portion of the liquid outlet portions comprises one of:
i) a mister outlet, which comprises the mounting portion and a mister nut, with a mister orifice, mounted on the mounting portion;
ii) an anvil outlet, which comprises the mounting portion and an anvil nut, with an anvil portion, mounted on the mounting portion; or
iii) a flat fan outlet, which comprises the mounting portion and a fan nut, with fan outlet portion, mounted on the mounting portion.

6. A pressure sprayer nozzle according to claim 1 in which the second outlet portion of the liquid outlet portions comprises an integral outlet component.

7. A pressure sprayer nozzle according to claim 1 in which the second outlet portion of the liquid outlet portions comprises a fan outlet for producing a fan spray pattern.

8. A pressure sprayer nozzle according to claim 1 in which the outlet head comprises at least three liquid outlet portions, wherein one of the liquid outlet portions comprises a mounting portion to which an outlet component is mountable and two outlet portions of the liquid outlet portions each comprise a respective integral outlet component.

9. A pressure sprayer nozzle according to claim 1 which comprises a retaining clip for releasably securing the outlet head on the main body portion.

10. A pressure sprayer nozzle according to claim 9 in which the retaining clip comprises at least one engagement portion for releasable engagement with a complementary engagement portion on the outlet head and the retaining clip comprises a clip body portion for bearing on a surface of the main body to hold the outlet head on the main body portion during relative rotation between the outlet head and the main body.

11. A pressure sprayer nozzle according to claim 10 in which the outlet head is cup shaped comprising a base portion and a sidewall portion defining an interior of the cup which is arranged to receive the main body portion, the liquid outlet portions are provided on the base portion and the sidewall extends from the base towards the rear of the main body, wherein the retaining clip is engaged with the sidewall when the outlet head is on the main body and the retaining clip is in place, and the clip body portion bears on a surface of the main body which faces away from the base of the cup when the outlet head is on the main body and the retaining clip is in place.

12. A pressure sprayer nozzle according to claim 10 in which the retaining clip is resilient and elastically deformable away from a first engaged position in which the at least one engagement portion is engaged with the complementary engagement portion on the outlet head to a second position in which the at least one engagement portion is not engaged with the complementary engagement portion on the outlet head and the retaining clip is disengagable from the outlet head so allowing removal of the outlet head from the main body.

13. A pressure sprayer nozzle according to claim 1 in which the seal comprises a first O-ring mounted on the main body portion so as to surround the outlet of the inlet channel and face a surface of the outlet head.

14. A pressure sprayer nozzle according to claim 13 in which the main body portion and the outlet head are arranged so that in the first position a first outlet portion of the plurality of liquid outlet portions is rotationally aligned with the inlet channel and the first O-ring seals around the inlet of the first liquid outlet portion and in the second position a second outlet portion of the plurality of liquid outlet portions is rotationally aligned with the inlet channel and the first O-ring seals around the inlet of the second liquid outlet portion.

15. A pressure sprayer nozzle according to claim 13 comprising a plurality of O-rings mounted on the main body portion so as to face the surface of the outlet head, said plurality comprising the first O-ring which surrounds the outlet of the inlet channel and at least one further O-ring.

16. A pressure sprayer nozzle according to claim 15 in which the number of O-rings in the plurality of O-rings matches the number of liquid outlet portions in the plurality of liquid outlet portions and an angular spacing between the 0-rings matches an angular spacing between the inlets of the liquid outlets.

17. A pressure sprayer nozzle according to claim 16 in which the O-rings are positioned and dimensioned so that when the outlet head is in the first position with the first O-ring sealing around the inlet of the first liquid outlet portion, each of the further O-rings seals around the inlet of a respective other one of the liquid outlet portions.

18. A pressure sprayer comprising a vessel for holding liquid to be sprayed, a pressurising mechanism for pressurising the vessel to yield a pressure in the vessel for driving liquid out of the vessel during spraying and a liquid outlet arrangement for allowing liquid to exit the vessel and leave the sprayer during spraying, wherein the liquid outlet arrangement comprises a pressure sprayer nozzle according to claim 1 and a vessel outlet portion which leads towards the pressure sprayer nozzle.

19. The pressure sprayer according to claim 18 which is a garden pressure sprayer arranged for delivering one or more of water, plant feed, pesticides, herbicides and fungicides in the garden.

20. A kit comprising a pressure sprayer nozzle according to claim 2, and at least two outlet components which are of different type from each other for selectively mounting on the mounting portion.

21. A kit comprising a pressure sprayer nozzle according to claim 3, and at least two outlet components which are of different type from each other for selectively mounting on the mounting portion.
